(19) United States
(12) Patent Application Publication
(10) Pub. No.: US 2003/0107889 A1
(43) Pub. Date: Jun. 12, 2003

(54) Structure of light bulb series

(76) Inventor: Wen-Ting Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/004,797

(22) Filed: Dec. 7, 2001

(51) Int. Cl. F21V 21/00

(52) U.S. Cl. 362/249

(57) ABSTRACT

Each of light bulb assemblies of a light bulb series of the present invention comprises following elements. A base body is having a receiving cavity inside and two conductor holes are positioned in its bottom. An aligning block, configured on a bottom surface of the receiving cavity, held around with an annular frame are respectively positioned two penetrating openings on both sides of the aligned block. A soft holder, holding a light bulb, inserted into the receiving cavity are configured two terminal conductor wires, which are respectively passing through those conductor holes, electrically coupling within its bottom edge. A base plug is formed by configured two fixed pieces on a plate body, wherein two fixed pieces are respectively having a rectangle-like extension portion in a top end and passing through those penetrating openings and positioned in both sides of the soft holder. A light bulb inserted into the soft fuse of the soft holder is hooded by a light bulb housing, which is fixed on the base body. The present invention can achieve waterproof protection, easy fabrication, and varied appearance effect.

### BACKGROUND OF THE INVENTION

1. Field of the Invention

The present invention generally relates to a structure of decorative light bulb series, and more particularly relates to an improved structure of a varied light bulb series.

2. Description of the Prior Art

With the enhancing living standard, people pay much attention to raise the quality and interest of life. For example, people will commonly dress up their living house with many ornaments and decorated-lamps on the specific festival day to embellish or create a happy festivities ambiance, especially on the festivities of the Christmas and the Easter. Public are much fond of the Christmas light bulb series, so the requirement of the varied and artistic appearance of the decorated-lamp is correspondingly much valued. However, the light bulb series is belonging to electric equipments, so the structure and the security of the light bulb series should be more exactly concerned.

Referring to the FIG. 1, a conventional light bulb series is formed by configured a plurality of light bulb assemblies on an electric cord. Each of those light bulb assemblies comprises a soft holder 12, wherein there is a conductor element, such as a copper circle, in the inner wall of the soft holder (such as not shown in the figure) and the copper circle is electrically coupling with a terminal conductor wire 14. In the bottom edge of the light bulb 16 is a copper head 18, wherein the copper head is formed as an external helix shape 20 so as to electrically connect. This light bulb series is more complex in the fabricating process and having less variation to replace different light bulb housings. Because it uses a precious metal material, such as copper head, so it increases the cost and the cost will transfer on those customers. Furthermore, the conventional light bulb series could not provide the waterproof protection and the copper head or the copper circle is easily become rusty to damage the interior structure when it contact water or humidity.

Obviously, the main spirit of the present invention is to provide a waterproof and high-varied structure of a light bulb series, in accordance with the requirement of the forgoing.

### SUMMARY OF THE INVENTION

The primary object of the invention is to provide a structure of a light bulb series, which the present structure can provide the waterproof effect with a simplifying assembling process. The present structure can extensively replace the light bulb housing of the light bulb series to have a varied appearance.

Another object of the invention is to provide a structure of a light bulb series, which has a low cost and a good competition of cheap-price.

In order to achieve previous objects, the present invention provides a structure of a light bulb series, which is formed by configured a plurality of light bulb assemblies on an electric cord. Wherein, each of those light bulb assemblies of the structure comprises following essential elements. First, a base body is having a receiving cavity inside and there are two conductor holes positioned in a bottom of the base body. Then, an aligning block is configured on a bottom surface of the receiving cavity, wherein the aligning block is held around by an annular frame and there are two penetrating openings respectively positioned on both sides of the aligned block of the bottom surface of the base body. Besides, a soft holder is having two terminal conductor wires electrically coupling within a bottom edge of the soft holder and a soft fuse is configured inside the soft holder. Wherein, the soft holder is configured on the aligning block in the receiving cavity and those two terminal conductor wires are respectively passing through the conductor holes out of the base body. Then, a base plug is formed by configuring two fixed pieces on a surface of a plate body and those fixed pieces are respectively having a rectangle-like extension portion in a top end of those fixed pieces. Wherein, those fixed pieces are respectively passing through those penetrating openings into the base body and those rectangle-like extension portions in the top end of those fixed pieces are engaged with a top edge of the annular frame to make the two fixed pieces positioned in both sides of the soft holder. Finally, a light bulb is inserted into the soft fuse of the soft holder, wherein a light bulb housing is fixed on the base body to hood the light bulb.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a three-dimensional decomposed schematic representation of a light bulb assembly of a light bulb series, in accordance with prior techniques;

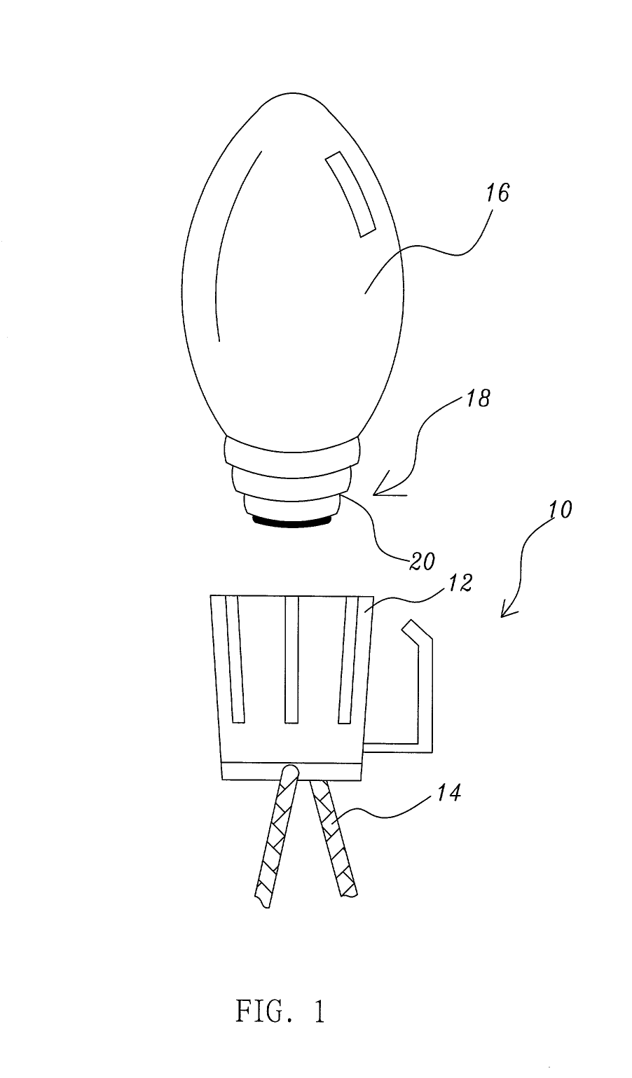

FIG. 2 is a three-dimensional schematic representation of a light bulb assembly of a light bulb series, in accordance with the present invention;

FIG. 3 is a three-dimensional decomposed schematic representation of a light bulb assembly of a light bulb series, in accordance with the present invention;

FIG. 4 is a schematic representation of a cross-section view of a light bulb assembly of a light bulb series, in accordance with one preferred embodiment of the present invention; and

FIG. 5A and FIG. 5D are schematic representations structures at various embodiments of a light bulb assembly of a light bulb series, in accordance with one preferred embodiment of the present invention.

### DESCRIPTION OF THE PREFERRED EMBODIMENT

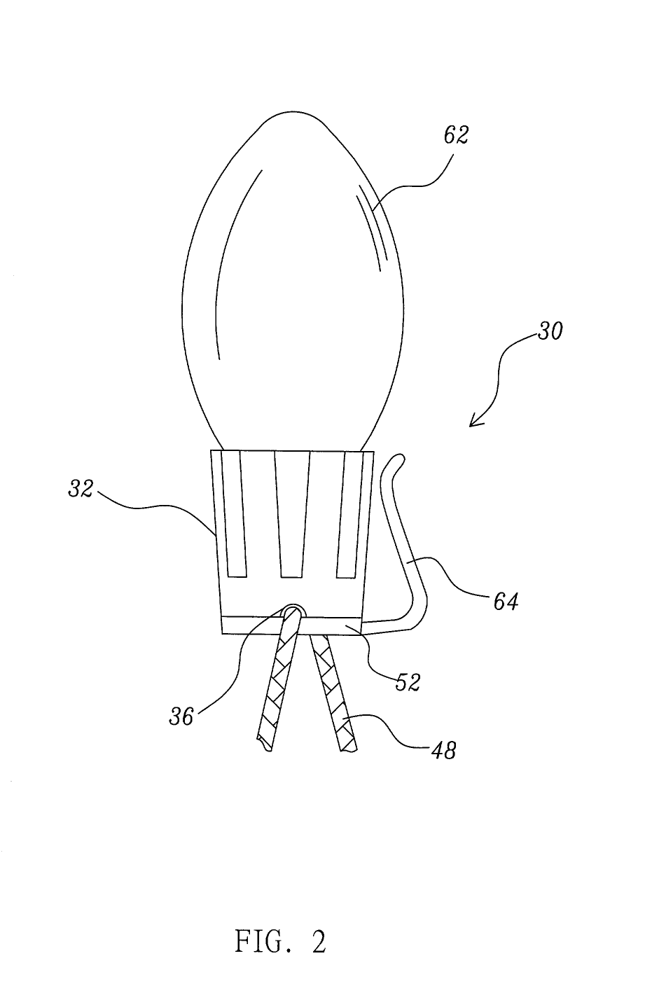

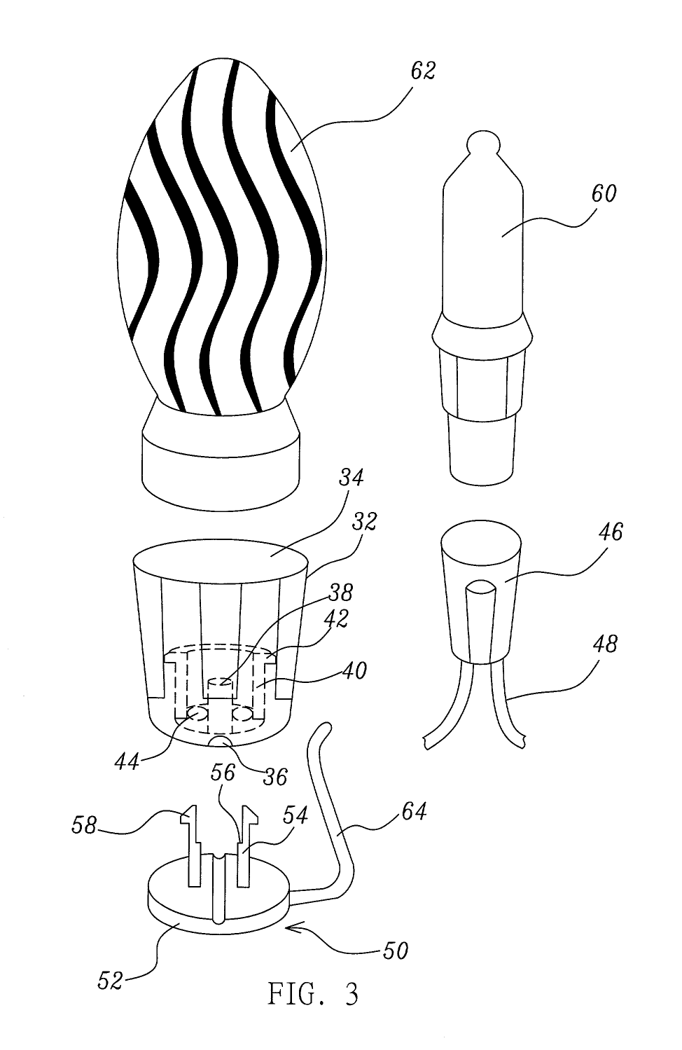

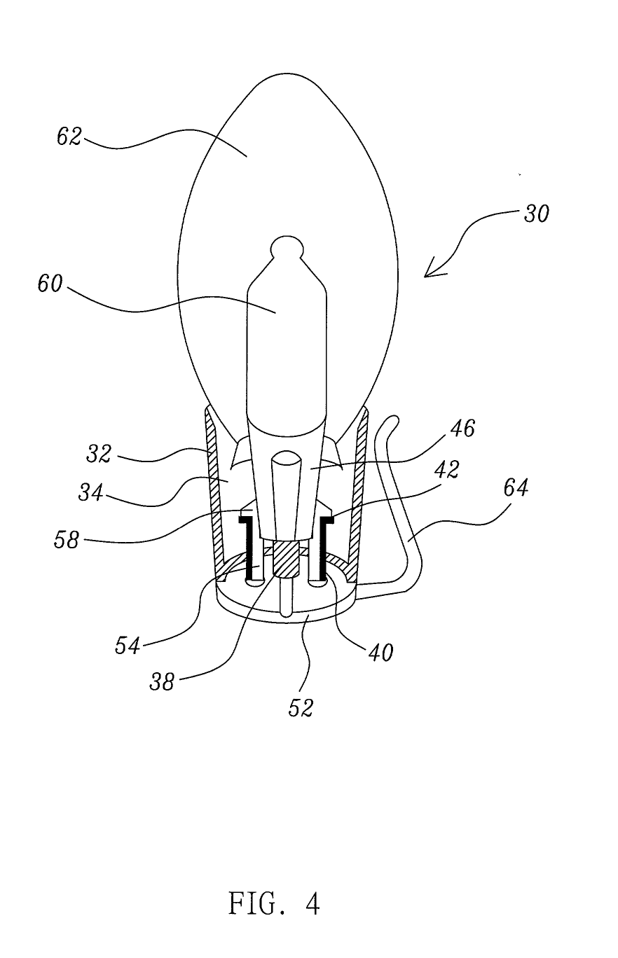

Referring to FIG. 2 and FIG. 3, a light bulb series is fabricated by configured a plurality of light bulb assemblies on an electric cord. Each of those light bulb assemblies 30 comprises a base body 32. Inside the base body 32 is a receiving cavity 34 and in a proper portion of the bottom of the base body 32 is configured two corresponding conductor holes 36. In the bottom surface of the receiving cavity 34, an aligning block 38 is configured thereon and an annular frame 40 is revolving around the aligning block 38, wherein the annular frame 40 has an extension portion 42 in the external top edge surface. There are configured two penetrating openings 44 in the bottom surface of the base body 32, wherein those penetrating openings 44 are respectively in both sides of the aligning block 38 and within the area of the annular frame 40. A soft holder 46 is configured on the aligning block 38 in the receiving cavity 34, wherein there are two terminal conductor wires electrically coupling within the bottom edge of the soft holder 46 and those terminal conductor wires 48 are crooked and respectively pass through those conductor holes 36 out of the base body 32. Two fixed pieces 54 configured on a surface of a plate body 52 is formed a base plug 50. The corresponding two surfaces of those fixed pieces are respectively having a corresponding indentation 56 and the top edge of two fixed pieces 54 are respectively crooked to different sides so as to form a rectangle-like extension portion 58 in the top end of two fixed pieces 54. The circular plate body 52 is joined and fixed with the external bottom surface of the base body 32 and merely two terminal conductor wires 48 are penetrating out of the base body 32, wherein two fixed pieces 54 are inserted into the base body 32 by passing through those penetrating openings 44 and engaged with both sides of the soft holder 46. Those rectangle-like extension s 58 in the top end of two fixed pieces 54 are engaged with the extension portion 42 of the annular frame 40 and two indentations 56 of two fixed pieces are respectively holding or supporting the bottom edge of the soft holder 46, as shown in FIG. 4, to fix the soft holder 46 without swinging or falling off. However, there is a soft fuse (such as not shown in the figure) in the soft holder 46 to use to inset a light bulb 60 and a light bulb housing 62 is fixed on the top edge of the base body 32 to hood the light bulb 60.

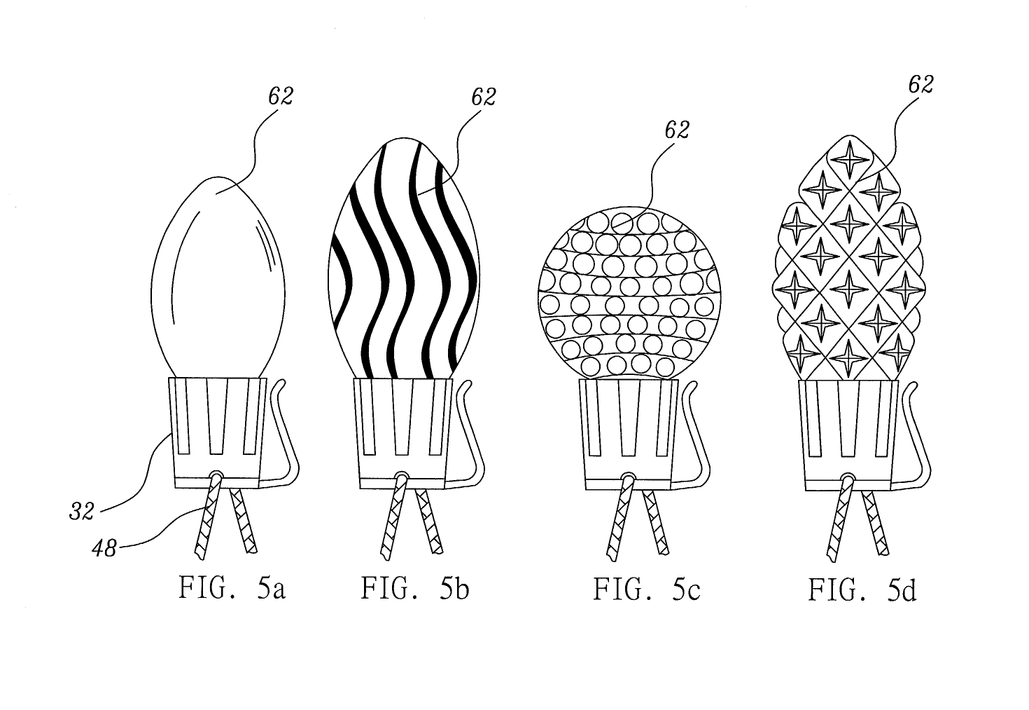

As mentioned above, the circular plate body 52 of the base plug 50 is made of a waterproof material and is configured a S type hook element 64 in one side of the circular plate body 52 to provide the hanging effect for the light bulb assembly 30. So as the light bulb series of the present invention can be hung on a normal Christmas tree or on a Christmas wreath of flowers and also can be used as an ornament to dress our surrounding or improve our quality of life. In the present invention, the light bulb housing 62 can immediately replace at everyone's choice and require according to its appearance or decoration pattern. However, the light bulb housing 62 also could be simple or sober, such as shown in the FIG. 5A, or the light bulb housing 62 is designed with a streamline pattern or a granular pattern, such as shown in the FIG. 5B and FIG. 5C. Furthermore, the light bulb housing 62 also can be directly formed lumpy pattern thereon. Referring to the FIG. 5D, the emitting light from the inside of the bulb light can be substantially varied designed and varied depending on different patterns of the light bulb housing 62 and the different brightness of the light bulb, but will not destroy the original style and features of the light bulb series. The artistic appearance design of the present invention can provide a better decorating effect and a better economic value.

With the waterproof design of the base plug 50 of the present invention, water or humidity could not diffuse or penetrate into the interior of the base body 32 so as the light bulb assembly 30 can provide the waterproof protection. The present invention is effectively simplifying the structure of the light bulb assembly and the fabricating process of a light bulb series. Hence, the present invention is substantially decreasing the cost to obtain an actual economic benefit.

While the present invention has been described in conjunction with preferred embodiments thereof, it is evident that many alternative, modifications and variations will be apparent to those skilled in the art. Accordingly, it is intended to embrace all such alternatives, modifications and variations that fall within the spirit and scope thereof as set forth in the appended claims.

What is claimed is:

1. A structure of a light bulb series which is configuring a plurality of light bulb assemblies on an electric cord, wherein each of said light bulb assemblies comprising:
a base body having a receiving cavity inside and two conductor holes positioning in a bottom of said base body;
an aligning block configured on a bottom surface of said receiving cavity, wherein said aligning block is held around by an annular frame, and there are two penetrating openings respectively on both sides of said aligned block of said bottom surface of said base body;
a soft holder having two terminal conductor wires electrically coupling within a bottom edge of said soft holder and having a soft fuse configured inside said soft holder, wherein said soft holder is positioned on said aligning block in said receiving cavity and said two terminal conductor wires are respectively passing through said conductor holes out of said base body;
a base plug formed by configuring two fixed pieces on a surface of a plate body, wherein said fixed pieces respectively have a rectangle-like extension portion in a top end of said fixed pieces, wherein said fixed pieces are respectively passing through said penetrating openings into said base body and said rectangle-like extension portions in the top end of said fixed pieces are engaged with a top edge of said annular frame to make said two fixed pieces positioned in both sides of said soft holder; and
a light bulb inserted into said soft fuse of said soft holder, wherein a light bulb housing is fixed on said base body to hood said light bulb.

2. The structure of said light bulb series according to claim 1, wherein said base plug is made of waterproof material.

3. The structure of said light bulb series according to claim 1, wherein said base body is formed having an extension portion of a bottom rim of said base body.

4. The structure of said light bulb series according to claim 1, wherein each of said fixed pieces are having a corresponding indentation respectively of two corresponding surfaces of said fixed pieces.

5. The structure of said light bulb series according to claim 1, wherein one side of said plate body is configured a hanging apparatus.

6. The structure of said light bulb series according to claim 5, wherein said hanging apparatus is a hook element.
